(19) United States
(12) Patent Application Publication
(10) Pub. No.: US 2025/0238969 A1
(43) Pub. Date: Jul. 24, 2025

(54) DISPLAY CONTROL APPARATUS

(71) Applicant: NTT DOCOMO, INC., Tokyo (JP)

(72) Inventor: Tomohito YAMASAKI, Chiyoda-ku (JP)

(73) Assignee: NTT DOCOMO, INC., Tokyo (JP)

(21) Appl. No.: 18/832,261

(22) PCT Filed: Feb. 2, 2023
(86) PCT No.: PCT/JP2023/003371

§ 371 Date: Jul. 23, 2024

(30) Foreign Application Priority Data
Feb. 4, 2022 (JP) 2022-016231

(51) Int. Cl. G06T 11/00

(52) U.S. Cl. CPC G06T 11/00

(57) ABSTRACT

A display control apparatus includes a generator configured to generate a virtual object to be placed in a first virtual space visually recognized by a user who is a sender of a message, the virtual object being related to the message; and a setter configured to set whether to permit a change in an appearance of the virtual object to be displayed in a second virtual space visually recognized by a user who is a recipient of the message.

### TECHNICAL FIELD

The present invention relates to display control apparatuses.

### BACKGROUND ART

When a message or content is delivered in a virtual space, specifications for display of a virtual object indicative of the message or of the content may be changed.

For example, Patent Document 1 discloses a technique for a content delivery server configured to provide education content in a remote education system. In the content delivery server, a material data distributor provides an education terminal device with first specification data, which indicates specifications of a plurality of virtual objects to be placed in a virtual space, and motion data, which indicates motions of the plurality of virtual objects. In addition, a material data changer changes the first specification data into second specification data in accordance with a request received from the education terminal device. Thereafter, the material data distributor provides the education terminal device with the second specification data. In other words, in the conventional remote education system, an appearance of a virtual object to be displayed by the recipient education terminal is changed in accordance with the request received from a user who is a recipient of the virtual objects.

### RELATED ART DOCUMENT

### Patent Document

Patent Document 1: Japanese Patent Application Laid-Open Publication No. 2021-006894

### SUMMARY OF THE INVENTION

### Problem to be Solved by the Invention

It may be desirable for a change in an appearance of a virtual object to be controlled by a system rather than by a user who is a recipient. However, in the prior art, an appearance of a virtual object to be displayed by a recipient education terminal is changed in accordance with a request received from a user who is a recipient. Thus, it is impossible for a server, etc., which transmits the virtual object, to determine whether to change an appearance of a virtual object.

An object of the present invention is to provide a display control apparatus for enabling a sender to set whether to permit a change in an appearance of a virtual object to be displayed by a recipient device.

### Means for Solving Problem

A display control apparatus according to a preferred aspect of the present invention is a display control apparatus that includes a generator configured to generate a virtual object to be placed in a first virtual space visually recognized by a user who is a sender of a message, the virtual object being related to the message; and a setter configured to set whether to permit a change in an appearance of the virtual object to be displayed in a second virtual space visually recognized by a user who is a recipient of the message.

### Effect of Invention

According to the present invention, it is possible for a sender to set whether to permit a change in an appearance of a virtual object to be displayed on a recipient device.

### BRIEF DESCRIPTION OF THE DRAWINGS

FIG. 1 is a diagram showing an overall configuration of an information processing system 1.

FIG. 2 is a perspective view of an appearance of a display 30-K.

FIG. 3 is an explanatory diagram showing a display method implemented by the display 30-K.

FIG. 4 is a block diagram showing an example of a configuration of the display 30-K.

FIG. 5 is a block diagram showing an example of a configuration of a terminal device 20-K.

FIG. 6 is a block diagram showing an example of a configuration of a server 10.

FIG. 7 is a sequence diagram showing an operation of the information processing system 1.

FIG. 8 is a block diagram showing an example of a configuration of a terminal device 20A-K.

FIG. 9 is a block diagram showing an example of a configuration of a server 10A.

FIG. 10 is a sequence diagram showing an operation of an information processing system 1A.

FIG. 11 is a diagram showing an example of a virtual object VO2.

### MODES FOR CARRYING OUT THE INVENTION

1: First Embodiment

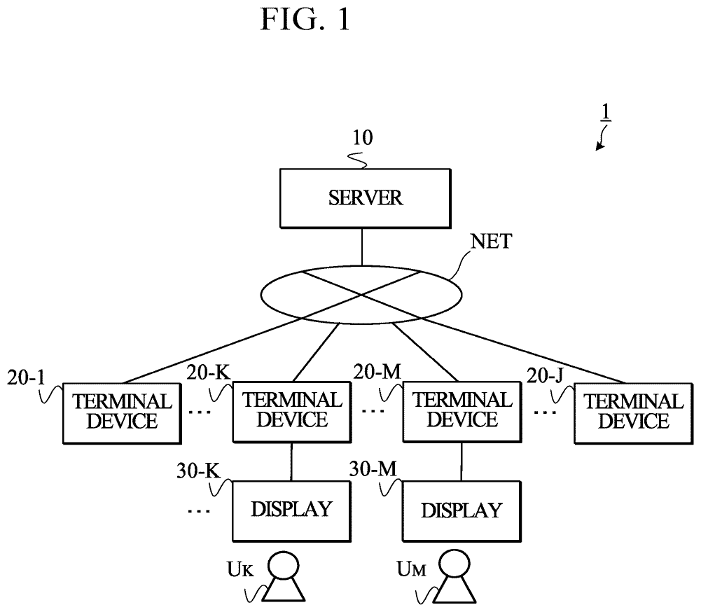

With reference to FIG. 1 to FIG. 7, an information processing system 1, which includes a server 10 as a display control apparatus according to a First Embodiment of the present invention, will be described.

### 1-1: Configuration of First Embodiment

### 1-1-1: Overall Configuration

FIG. 1 shows an overall configuration of the information processing system 1. As shown in FIG. 1, the information processing system 1 includes a server 10, terminal devices 20-1, 20-2 . . . 20-K . . . 20-M . . . 20-J, and displays 30-K and 30-M. J is an integer greater than or equal to 1. K is an integer greater than or equal to 1, and less than or equal to J. M is an integer greater than or equal to 1, and less than or equal to J, and is a different integer from K. In this embodiment, the terminal devices 20-1 to 20-J have the same configuration. However, a terminal device may be included that has a configuration that is not the same as that of another terminal device. In this embodiment, the displays 30-K and 30-M have the same configuration. However, a display may be included that has a configuration that is not the same as that of another display.

In the information processing system 1, the server 10 and the terminal devices 20-1 to 20-J are connected to, and are communicable with, each other via a communication network NET. The terminal device 20-K and the display 30-K are connected to, and are communicable with, each other. Similarly, the terminal device 20-K and the display 30-K are connected to, and are communicable with, each other. In FIG. 1, a user U_{K} uses a combination of the terminal device 20-K and the display 30-K. A user U_{M} uses a combination of the terminal device 20-M and the display 30-M.

The server 10 provides various types of data and cloud services to the terminal devices 20-1, 20-2 . . . 20-K . . . 20-M . . . 20-J via the communication network NET.

The terminal device 20-K causes the display 30-K worn on the head of the user U_{K} to display a virtual object placed in a virtual space. The virtual space is, for example, a celestial spherical space. Examples of the virtual object include a virtual object indicative of an application and a virtual object indicative of data such as a still image, a video, a 3DCG model, a HTML file, and a text file. Examples of the text file include notes, source codes, diaries, and recipes. Examples of the application include a web browser, an application for using an SNS, and an application for generating document files. The terminal device 20-K is preferably a mobile terminal device such as a smartphone and a tablet. The terminal device 20-M similarly causes the display 30-M worn on the head of the user U_{M} to display a virtual object placed in a virtual space.

In this embodiment, the user U_{K} wearing the display 30-K on the head uses the terminal device 20-K to transmit a message to another user U_{M}. Specifically, as described below, the user U_{K} places a virtual object that is related to the message in a virtual space and specifies an address of the user U_{M} to transmit the message to the user U_{M}.

A terminal device other than the terminal devices 20-K and 20-M among the terminal devices 20-1 to 20-J may be connected to a display that has a configuration that is the same as that of each of the displays 30-K and 30-M.

### 1-1-2: Configuration of Display

The display 30-K is a device for displaying the virtual object placed in the virtual space, as described above. The display 30-K may be a pair of virtual reality (VR) glasses, in which a VR technique for providing the user U_{K} with a virtual reality space is adopted, or it may be a pair of VR goggles, in which the VR technique is adopted. Alternatively, the display 30-K may be a pair of augmented reality (AR) glasses, in which an AR technique for providing the user U_{K} with an augmented reality space is adopted, or it may be a pair of AR goggles, in which the AR technique is adopted. Alternatively, the display 30-K may be a pair of mixed reality (MR) glasses, in which a MR technique for providing the user U_{K} with a mixed reality space is adopted, or it may be a pair of MR goggles, in which the MR technique is adopted. Alternatively, the display 30-K may be a head mounted display (HMD) in which either the VR technique, the AR technique, or the MR technique is adopted. When the display 30-K is an HMD, the HMD may serve as two or more types of pairs of goggles among the pair of VR goggles, the pair of AR goggles, and the pair of MR goggles. The same manner may be applied to the display 30-M.

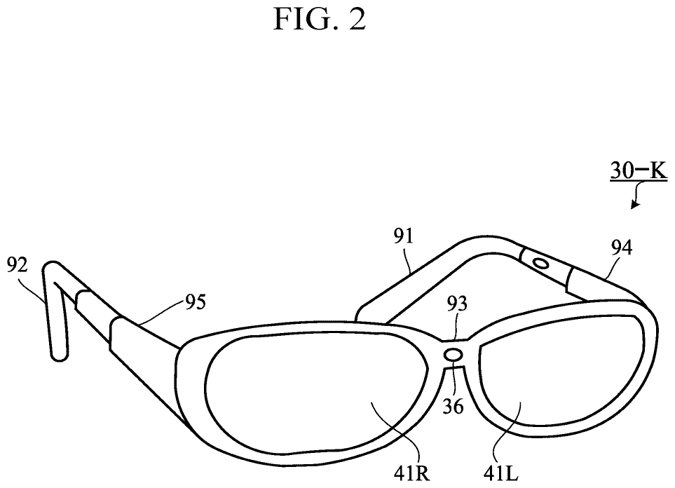

FIG. 2 is a perspective view showing an appearance of the display 30-K in a case in which the display 30-K is a pair of AR glasses, which is an example of the display 30-K. As shown in FIG. 2, the display 30-K, as well as a typical pair of glasses, has temples 91 and 92, a bridge 93, frames 94 and 95, and lenses 41L and 41R.

The bridge 93 is provided with a capturing device 36. The capturing device 36 captures the outside world. The capturing device 36 provides captured image information indicative of a captured image.

Each of the lenses 41L and 41R includes a one-way mirror. The frame 94 is provided with either a liquid crystal panel for the left eye or an organic EL panel for the left eye. The liquid crystal panel or the organic EL panel is collectively referred to as a display panel. The frame 94 is provided with an optical member for guiding light beams, which are emitted by the display panel for the left eye, to the lens 41L. Light beams from the outside world pass through the one-way mirror provided in the lens 41L to be directed to the left eye of the user, and light beams guided by the optical member to the lens 41L are reflected by the one-way mirror to be directed to the left eye of the user. The frame 95 is provided with a display panel for the right eye and with an optical member for guiding light beams, which are emitted by the display panel for the right eye, to the lens 41R. Light beams from the outside world pass through the one-way mirror provided in the lens 41R to be directed to the right eye of the user, and light beams guided by the optical member to the lens 41R are reflected by the one-way mirror to be directed to the right eye of the user.

A display 39 described below includes the lens 41L, the display panel for the left eye, the optical member for the left eye, the lens 41R, the display panel for the right eye, and the optical member for the right eye.

According to the configuration described above, the user U_{K} can watch images displayed by the display panel in a transparent state in which the images are superimposed on images of the outside world. The display 30-K causes the display panel for the left eye to display a left-eye image of stereo-pair images, and causes the display panel for the right eye to display a right-eye image of the stereo-pair images. Thus, the display 30-K causes the user U_{K} to feel as if the displayed images have depth and a stereoscopic effect.

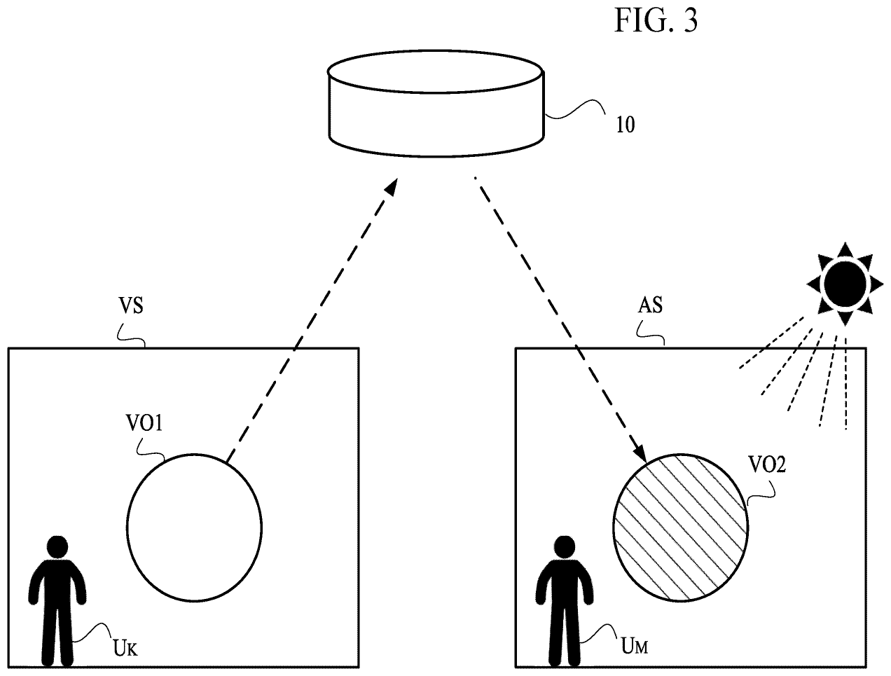

FIG. 3 an explanatory diagram showing a display method implemented by the display 30-K in this embodiment. In FIG. 3, a virtual reality space VS is provided to the user U_{K} who uses a pair of VR glasses that is an example of the display 30-K. On the other hand, an augmented reality space AS is provided to the user U_{M} who uses a pair of AR glasses that is an example of the display 30-M. The virtual reality space VS is an example of a first virtual space. The augmented reality space AS is an example of a second virtual space.

The user U_{K} places a virtual object VO1, which is related to the message, in the virtual reality space VS. The user U_{K} then specifies the user U_{M} as a recipient. Then, the message corresponding to the virtual object VO1 is transmitted via the server 10 to the terminal device 20-M used by the user U_{M}. When the message is transmitted to the terminal device 20-M, the virtual object VO1 related to the message is displayed as a virtual object VO2 in the augmented reality space AS. An appearance of the virtual object VO2 is basically the same as that of the virtual object VO1. However, since the virtual object VO2 is displayed in the augmented reality space AS, the appearance of the virtual object VO2 viewed by the user U_{M} varies in accordance with an environment in a real space included in the augmented reality space AS. Thus, the server 10 changes the appearance of the virtual object VO2 in accordance with the environment in the real space included in the augmented reality space AS such that the appearance of the virtual object VO2 is appropriately viewed by the user U_{M}.

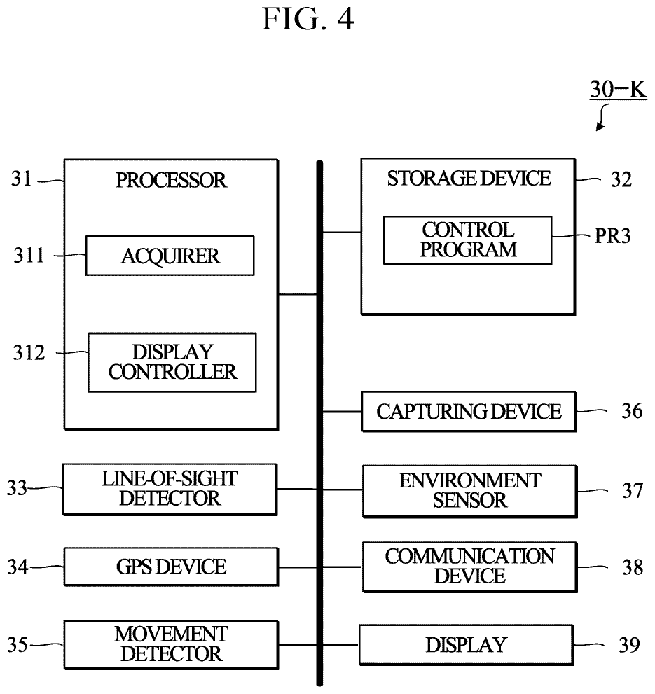

FIG. 4 is a block diagram showing a configuration of an example of the display 30-K in a case in which the display 30-K is a pair of AR glasses, which is an example of the display 30-K. The display 30-K includes a processor 31, a storage device 32, a line-of-sight detector 33, a GPS device 34, a movement detector 35, the capturing device 36, an environment sensor 37, a communication device 38, and the display 39. Each element of the display 30-K is interconnected by a single bus or by multiple buses for communicating information. The term “device” in this specification may be understood as equivalent to another term such as circuit, device, unit, etc.

The processor 31 is a processor configured to control the entire display 30-K. The processor 31 is constituted of a single chip or of multiple chips, for example. The processor 31 is constituted of a central processing unit (CPU) that includes, for example, interfaces for peripheral devices, arithmetic units, registers, etc. One, some, or all of the functions of the processor 31 may be implemented by hardware such as a digital signal processor (DSP), an application specific integrated circuit (ASIC), a programmable logic device (PLD), or a field programmable gate array (FPGA). The processor 31 executes various processing in parallel or sequentially.

The storage device 32 is a recording medium that is readable and writable by the processor 31. The storage device 32 stores a plurality of programs including a control program PR3 to be executed by the processor 31.

The line-of-sight detector 33 detects a line of sight of the user U_{K} to generate line-of-sight information indicative of a detection result. A method for detecting the line-of-sight, which is executed by the line-of-sight detector 33, may be freely selected. For example, the line-of-sight detector 33 may generate the line-of-sight information based on a location of an inner corner of an eye and a location of an iris. The line-of-sight information indicates a direction of the line-of-sight of the user U_{K}. The line-of-sight detector 33 provides the line-of-sight information to the processor 31 described below. The line-of-sight information provided to the processor 31 is provided to the terminal device 20-K via the communication device 38.

The GPS device 34 receives radio waves from a plurality of satellites. The GPS device 34 generates location information from the received radio waves. The location information indicates a location of the display 30-K. The location information may be in any form as long as the location can be specified. The location information indicates a latitude and longitude of the display 30-K, for example. For example, the location information is obtained from the GPS device 34. However, the display 30-K may acquire the location information using another method. The acquired location information is provided to the processor 31. The location information provided to the processor 31 is transmitted to the terminal device 20-K via the communication device 38.

The movement detector 35 detects movement of the display 30-K. The movement detector 35 is an inertial sensor such as an acceleration sensor for sensing acceleration and a gyro sensor for sensing angular acceleration. The acceleration sensor senses acceleration in a direction along each of the X-axis, the Y-axis, and the Z-axis that are perpendicular to one another. The gyro sensor senses angular acceleration of rotation having a rotation axis that is each of the X-axis, the Y-axis, and the Z-axis. The movement detector 35 can generate orientation information indicative of an orientation of the display 30-K based on output information from the gyro sensor. Movement information includes acceleration data indicative of acceleration for each of the three axes and angular acceleration data indicative of angular acceleration for each of the three axes. The movement detector 35 provides the processor 31 with the orientation information indicative of the orientation of the display 30-K and the movement information on the movement of the display 30-K. The orientation information and the movement information provided to the processor 31 are provided to the terminal device 20-K via the communication device 38.

The capturing device 36 provides the captured image information obtained by capturing the outside world. The capturing device 36 includes lenses, a capturing element, an amplifier, and an AD converter, for example. Light beams focused through the lenses are converted by the capturing element into a captured image signal, which is an analog signal. The amplifier amplifies the captured image signal and provides the amplified captured image signal to the AD converter. The AD converter converts the amplified captured image signal, which is an analog signal, into the captured image information, which is a digital signal. The captured image information, which has been made through the conversion, is provided to the processor 31. The captured image information provided to the processor 31 is provided to the terminal device 20-K via the communication device 38.

The environment sensor 37 senses an environment around the display 30-K. The environment sensor 37 includes an ambient light sensor configured to sense illuminance. The environment sensor 37 may further sense temperature, humidity, atmospheric pressure, etc., as appropriate. The environment sensor 37 generates environment information based on a sensing result. The environment sensor 37 provides the generated environment information to the processor 31. The environment information provided to the processor 31 is transmitted to the terminal device 20-K via the communication device 38.

The communication device 38 is hardware that is a transmitting and receiving device configured to communicate with other devices. For example, the communication device 38 may be referred to as a network device, a network controller, a network card, a communication module, etc. The communication device 38 may include a connector for wired connection and an interface circuit corresponding to the connector for wired connection. The communication device 38 may include a wireless communication interface. The connector for wired connection and the interface circuit may conform to wired LAN, IEEE1394, or USB. The wireless communication interface may conform to wireless LAN or Bluetooth (registered trademark), etc.

The display 39 is a device for displaying images. The display 39 displays various types of images under control of the processor 21. The display 39 includes the lens 41L, the display panel for the left eye, the optical member for the left eye, the lens 41R, the display panel for the right eye, and the optical member for the right eye, as described above. As the display panel, a type of display panel such as a liquid crystal display panel or an organic EL display panel is preferably used, for example.

The processor 31 reads the control program PR3 from the storage device 32 and executes the read control program PR3. As a result, the processor 31 functions as an acquirer 311 and a display controller 312.

The acquirer 311 acquires image information indicative of an image to be displayed on the display 30-K from the terminal device 20-K.

The acquirer 311 acquires the line-of-sight information provided by the line-of-sight detector 33, the location information provided by the GPS device 34, the orientation information and the movement information provided by the movement detector 35, the captured image information provided by the capturing device 36, and the environment information provided by the environment sensor 37. Then, the acquirer 311 provides the line-of-sight information, the location information, the orientation information, the movement information, the captured image information, and the environment information, which are acquired, to the communication device 38.

The display controller 312 causes, based on the image information acquired by the acquirer 311 from the terminal device 20-K, the display 39 to display the image indicated by the image information.

### 1-1-3: Configuration of Terminal Device

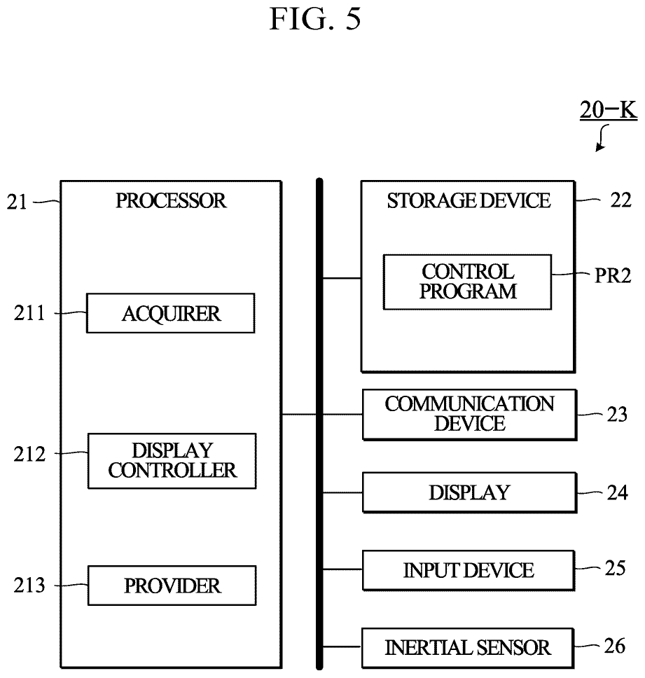

FIG. 5 is a block diagram showing an example of a configuration of the terminal device 20-K. The terminal device 20-K includes a processor 21, a storage device 22, a communication device 23, a display 24, an input device 25, and an inertial sensor 26. Each element of the terminal device 20-K is interconnected by a single bus or by multiple buses for communicating information.

The processor 21 is a processor configured to control the entire terminal device 20-K. The processor 21 is constituted of a single chip or of multiple chips, for example. The processor 21 is constituted of a central processing unit (CPU) that includes, for example, interfaces for peripheral devices, arithmetic units, registers, etc. One, some, or all of the functions of the processor 21 may be implemented by hardware such as a DSP, an ASIC, a PLD, or an FPGA. The processor 21 executes various processing in parallel or sequentially.

The storage device 22 is a recording medium readable and writable by the processor 21. The storage device 22 stores a plurality of programs including a control program PR2 to be executed by the processor 21. The storage device 22 may further store the image information indicative of the image to be displayed on the display 30-K.

The communication device 23 is hardware that is a transmitting and receiving device configured to communicate with other devices. For example, the communication device 23 may be referred to as a network device, a network controller, a network card, a communication module, etc. The communication device 23 may include a connector for wired connection and an interface circuit corresponding to the connector for wired connection. The communication device 23 may include a wireless communication interface. The connector for wired connection and the interface circuit may conform to wired LAN, IEEE1394, or USB. The wireless communication interface may conform to wireless LAN or Bluetooth (registered trademark), etc.

The display 24 is a device for displaying images and text information. The display 24 displays various types of images under control of the processor 21. As the display 24, a type of display panel such as a liquid crystal display panel and an organic electro luminescent (EL) display panel is preferably used, for example. When the terminal device 20-K is connected to the display 30-K, the display 24 need not be an essential element. Specifically, by using the display 30-K as the display 24, the terminal device 20-K need not be provided with the display 24.

The input device 25 receives operations by the user U_{K} wearing the display 30-K on the head. For example, the input device 25 includes a pointing device such as a keyboard, a touch pad, a touch panel, or a mouse. In a case in which the input device 25 includes a touch panel, the input device 25 may also serve as the display 24.

The inertial sensor 26 is a sensor for sensing inertial force. The inertial sensor 26 includes one or more sensors among an acceleration sensor, an angular velocity sensor, and a gyro sensor, for example. The processor 21 senses an orientation of the terminal device 20-K based on output information from the inertial sensor 26. The processor 21 further receives, based on the orientation of the terminal device 20-K, selection of the virtual object VO1, input of text, and input of instructions, in the virtual reality space VS or in the augmented reality space AS. For example, when the user U_{K} causes a central axis of the terminal device 20-K to face a predetermined region in the virtual reality space VS or in the augmented reality space AS and operates the input device 25, the virtual object VO1 disposed in the predetermined region is selected. The operation of the input device 25 by the user U_{K} is, for example, a double-tap. Thus, if the user U_{K} operates the terminal device 20-K as described above, the user U_{K} can select the virtual object VO1 without looking at the input device 25 of the terminal device 20-K. The processor 21 reads the control program PR2 from the storage device 22 and executes the program PR2. As a result, the processor 21 functions as an acquirer 211, a display controller 212, and a provider 213.

The acquirer 211 acquires the message created by the user U_{K} and address information indicative of an address for the message. The message and the address information indicative of the address for the message may be, for example, a message and address information input by the user U_{K} using the input device 25 to the terminal device 20-K. Alternatively, the message and the address information for the message may be a message and address information acquired by the processor 21 from an external device via the communication device 23.

The acquirer 211 acquires operation information indicative of an operation by the user U_{K}. The operation by the user U_{K} may be an operation of the input device 25, or it may be an operation of the virtual object VO1 in the first virtual space. The acquirer 211 further acquires the line-of-sight information, the location information, the orientation information, the movement information, the captured image information, and the environment information, from the display 30-K.

In the terminal device 20-M rather than in the terminal device 20-K, the acquirer 211 acquires the message, which is created by the user U_{K}, from the server 10. In the terminal device 20-M rather than in the terminal device 20-K, the acquirer 211 acquires operation information indicative of an operation by the user U_{M}. The operation by the user U_{M} may be an operation of the input device 25, or it may be an operation of the virtual object VO2 in the second virtual space.

The acquirer 211 acquires the image information for displaying a virtual object on the display 30-K from the server 10 via the communication device 23. In particular, the acquirer 211 acquires image information for displaying the virtual object VO1 related to the message acquired by the acquirer 211.

The acquirer 211, which is provided in the terminal device 20-M rather than in the terminal device 20-K, acquires image information for displaying a virtual object on the display 30-M from the server 10 via the communication device 23. In particular, the acquirer 211 provided in the terminal device 20-M acquires image information for displaying the virtual object VO2 related to the message acquired by the acquirer 211.

The display controller 212 causes the display 30-K to display a virtual object by using the image information acquired by the acquirer 211. In particular, the display controller 212 causes the display 30-K to display the virtual object VO1 related to the message by using the image information.

In the terminal device 20-M rather than in the terminal device 20-K, the display controller 212 causes the display 30-M to display a virtual object by using the image information acquired by the acquirer 211. In particular, the display controller 212 causes the display 30-M to display the virtual object VO2 related to the message by using the image information. The display controller 212 causes the display 30-M to display the message corresponding to the virtual object VO2.

The provider 213 transmits the message and the address information acquired by the acquirer 211 to the server 10 via the communication device 23.

The provider 213 provided in the terminal device 20-M rather than in the terminal device 20-K provides the environment information acquired by the acquirer 211 to the server 10.

### 1-1-4: Configuration of Server

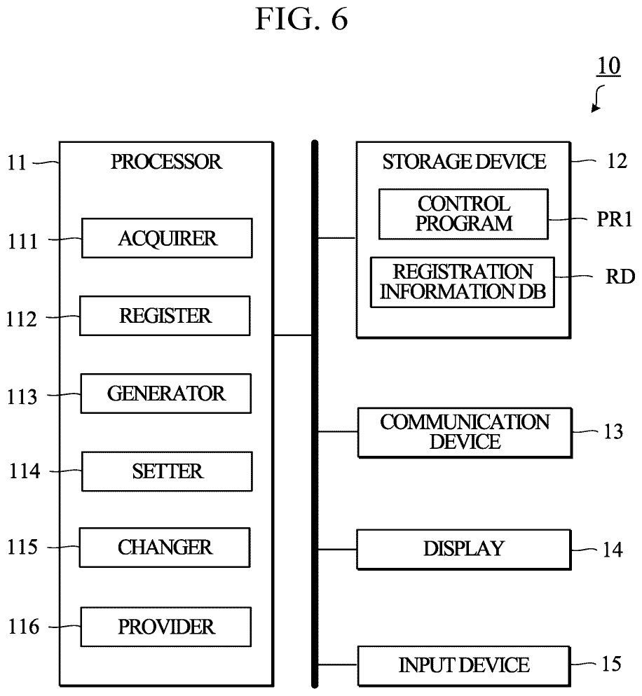

FIG. 6 is a block diagram showing an example of a configuration of the server 10. The server 10 includes a processor 11, a storage device 12, a communication device 13, a display 14, and an input device 15. Each element of the server 10 is interconnected by a single bus or by multiple buses for communicating information.

The processor 11 is a processor configured to control the entire server 10. The processor 11 is constituted of a single chip or of multiple chips, for example. The processor 11 is constituted of a central processing unit (CPU) that includes, for example, interfaces for peripheral devices, arithmetic units, registers, etc. One, some, or all of the functions of the processor 11 may be implemented by hardware such as a DSP, an ASIC, a PLD, or an FPGA. The processor 11 executes various processing in parallel or sequentially.

The storage device 12 is a recording medium readable and writable by the processor 11. The storage device 12 stores a plurality of programs including a control program PR1 to be executed by the processor 11. The storage device 12 further stores image information indicative of an image to be displayed on the display 30-K and of an image to be displayed on the display 30-M. In particular, the storage device 12 stores image information indicative of a virtual object to be displayed on the display 30-K and of a virtual object to be displayed on the display 30-M.

The storage device 12 further stores a registration information database RD. The registration information database RD stores a type of display 30-K, which is worn on the head of the user U_{K}, in association with the user U_{K} using the terminal device 20-K connected to the server 10, and a type of display 30-J, which is worn on the head of the user U_{M}, in association with the user U_{M} using the terminal device 20-J connected to the server 10. Specifically, information is stored that is in association with the user U_{K}, the information indicating that the display 30-K is a pair of VR glasses, that the display 30-K is an HMD to which a VR technique is applied, that the display 30-K is a pair of AR glasses, that the display 30-K is an HMD to which an AR technique is applied, that the display 30-K is a pair of MR glasses, or that the display 30-K is an HMD to which an MR technique is applied. In addition, information is stored that is in association with the user U_{M}, the information indicating that the display 30-J is a pair of VR glasses, that the display 30-J is an HMD to which a VR technique is applied, that the display 30-J is a pair of AR glasses, that the display 30-J is an HMD to which an AR technique is applied, that the display 30-J is a pair of MR glasses, or that the display 30-J is an HMD to which an MR technique is applied. The storage device 12 stores a type of virtual space, which is visually recognized by the user U_{K}, in association with the user U_{K}, and a type of virtual space, which is visually recognized by the user U_{M}, in association with the user U_{M}. Specifically, information is stored that is in association with the user U_{K}, the information indicating that the type of virtual space visually recognized by the user U_{K} is a virtual reality space, that the type of virtual space visually recognized by the user U_{K} is an augmented reality space, or that the type of virtual space visually recognized by the user U_{K} is a mixed reality space. In addition, information is stored that is in association with the user U_{M}, the information indicating that the type of virtual space visually recognized by the user U_{M} is a virtual reality space, that the type of virtual space visually recognized by the user U_{M} is an augmented reality space, or that the type of virtual space visually recognized by the user U_{M} is a mixed reality space.

The communication device 13 is hardware that is a transmitting and receiving device configured to communicate with other devices. For example, the communication device 13 may be referred to as a network device, a network controller, a network card, a communication module, etc. The communication device 13 may include a connector for wired connection and an interface circuit corresponding to the connector for wired connection. The communication device 13 may include a wireless communication interface. The connector for wired connection and the interface circuit may conform to wired LAN, IEEE1394, or USB. The wireless communication interface may conform to wireless LAN or Bluetooth (registered trademark), etc.

The display 14 is a device for displaying images and text information. The display 14 displays various types of images under control of the processor 11. As the display 14, a type of display panel such as a liquid crystal display panel and an organic EL display panel is preferably used, for example.

The input device 15 is a device for receiving operations by a manager of the information processing system 1. For example, the input device 15 includes a pointing device such as a keyboard, a touch pad, a touch panel, or a mouse. In a case in which the input device 15 includes a touch panel, the input device 15 may also serve as the display 14.

The processor 11 reads the control program PR1 from the storage device 12 and executes the read control program RP1, for example. As a result, the processor 11 functions as an acquirer 111, a register 112, a generator 113, a setter 114, a changer 115, and a provider 116.

The acquirer 111 acquires, from the terminal device 20-K via the communication device 13, the information indicative of the type of display 30-K, which is worn on the head of the user U_{K}, in association with the user U_{K}. The acquirer 111 acquires, from the terminal device 20-K via the communication device 13, the information indicative of the type of virtual space, which is visually recognized by the user U_{K}, in association with the user U_{K}. Similarly, the acquirer 111 acquires, from the terminal device 20-M via the communication device 13, the information indicative of the type of display 30-M, which is worn on the head of the user U_{M}, in association with the user U_{M}. The acquirer 111 acquires, from the terminal device 20-M via the communication device 13, the information indicative of the type of virtual space, which is visually recognized by the user U_{M}, in association with the user U_{M}.

The acquirer 111 acquires, from the terminal device 20-K via the communication device 13, the message and the address information indicative of the address of the message.

The acquirer 111 acquires, from the terminal device 20-K via the communication device 13, various types of data. The data includes data indicative of an operation of the virtual object VO1 input by the user U_{K}, who wears the display 30-K on the head, to the terminal device 20-K, for example. The data may include at least one of the line-of-sight information, the location information, the orientation information, the movement information, and the captured image information that are acquired by the terminal device 20-K from the display 30-K.

The acquirer 111 acquires, from the terminal device 20-M via the communication device 13, various types of data. The data includes data indicative of an operation of the virtual object VO2 input by the user U_{M}, who wears the display 30-M on the head, to the terminal device 20-M, for example. The data includes the environment information acquired by the terminal device 20-M from the display 30-M. The data may include at least one of the line-of-sight information, the location information, the orientation information, the movement information, and the captured image information that are acquired by the terminal device 20-M from the display 30-M.

The register 112 stores, in the registration information database RD, the information indicative of the type of display 30-K, which is worn on the head of the user U_{K}, in association with the user U_{K}, and the information indicative of the type of display 30-M, which is worn on the head of the user U_{M}, in association with the user U_{M}, which are acquired by the acquirer 111. The register 112 stores, in the registration information database RD, the information indicative of the type of virtual space, which is visually recognized by the user U_{K}, in association with the user U_{K}, and the information indicative of the type of virtual space, which is visually recognized by the user U_{M}, in association with the user U_{M}, which are acquired by the acquirer 111.

After acquiring the address information, the acquirer 111 described above refers to the registration information database RD to acquire information for distinguishing whether the second virtual space visually recognized by the user U_{M} corresponding to the address information is a virtual reality space, an augmented reality space, or a mixed reality space. The information for distinguishing whether the second virtual space is a virtual reality space, an augmented reality space, or a mixed reality space is an example of virtual space information. The virtual space information may be information indicating that the second virtual space is an augmented reality space, that the second virtual space is an augmented reality space, or that the second virtual space is a mixed reality space.

The generator 113 uses the image information stored in the storage device 12 to generate the virtual object VO1 to be placed in the first virtual space, the virtual object VO1 being related to the message from the user U_{K} acquired by the acquirer 111. The generator 113 uses the image information stored in the storage device 12 to generate the virtual object VO2 to be placed in the second virtual space, the virtual object VO2 being related to the message described above. At a point in time at which the generator 113 generates the virtual object VO1 and the virtual object VO2, the appearance of the virtual object VO1 is the same as the appearance of the virtual object VO2.

The setter 114 sets, based on the virtual space information acquired by the acquirer 111, whether to permit a change in the appearance of the virtual object VO2 in the second virtual space visually recognized by the user U_{M}. More specifically, when the second virtual space is a virtual reality space, the setter 114 does not permit the change in the appearance of the virtual object VO2. On the other hand, when the second virtual space is either an augmented reality space or a mixed reality space, the setter 114 permits the change in the appearance of the virtual object VO2.

As a result, the server 10 can set, in the server 10, whether to permit the change in the appearance of the virtual object VO2 indicative of the message in a recipient device of the message. Furthermore, the user U_{M} need not perform a complicated operation so as to make an appearance of the virtual object VO2 appropriately viewed by the user. In addition, the user U_{K} who is a sender of the message need not manually set, in accordance with a state of the user U_{M} who is a recipient of the message, whether to permit a change in the appearance of the virtual object VO1 displayed as the virtual object VO2 in the second virtual space.

In particular, in the server 10, the server 10 can set, in accordance with a state in which a space visually recognized by the user U_{M} who is a recipient of the message is a virtual reality space, in which the space visually recognized by the user U_{M} is an augmented reality space, or in which the space visually recognized by the user U_{M} is a mixed reality space, whether to permit the change in the appearance of the virtual object VO2.

When the setter 114 sets permission for the change in the appearance of the virtual object VO2, the changer 115 changes, based on the environment information acquired by the acquirer 111, the appearance of the virtual object VO2 to be displayed in the second virtual space. For example, when the environment information acquired by the acquirer 111 is illuminance information indicative of the illuminance measured by the ambient light sensor, the changer 115 changes at least one of the brightness, the saturation, and the hue of a color of the virtual object VO2 in accordance with the illuminance information.

As a result, the server 10 can make an appearance of the virtual object VO2 appropriately viewed by the user U_{M}. In particular, when the second virtual space visually recognized by the user U_{M} is an augmented reality space or a mixed reality space, the server 10 can make the appearance of the virtual object VO2 appropriately viewed by the user U_{M} in accordance with an environment in the real space included in the augmented reality space or in the mixed reality space.

The provider 116 transmits the image information, which indicates the image to be displayed on the display 30-K, to the terminal device 20-K via the communication device 13. In particular, the provider 116 transmits image information, which indicates the virtual object VO1, to the terminal device 20-K. The provider 116 transmits the image information, which indicates the image to be displayed on the display 30-M, to the terminal device 20-M via the communication device 13. In particular, the provider 116 transmits image information, which indicates the virtual object VO2, to the terminal device 20-M.

More specifically, when the setter 114 sets no permission for the change in the appearance of the virtual object VO2 or when the changer 115 does not change the appearance of the virtual object VO2 in a state in which the setter 114 sets the permission, the provider 116 transmits image information, which indicates the virtual object VO2 that is generated by the generator 113 and that is not changed, to the terminal device 20-M. On the other hand, when the setter 114 sets the permission for the change in the appearance of the virtual object VO2 and the changer 115 changes the appearance of the virtual object VO2, the provider 116 transmits image information, which indicates the virtual object VO2 having a changed appearance, to the terminal device 20-M.

When the acquirer 111 acquires operation information, which indicates an operation for an instruction to display the message related to the virtual object VO2 as an operation of the virtual object VO2 by the user U_{M}, from the terminal device 20-M, the provider 116 transmits the message to the terminal device 20-M. The message described above is the message for the user U_{M} created by the user U_{K}, which is acquired by the acquirer 111.

### 1-2: Operation of First Embodiment

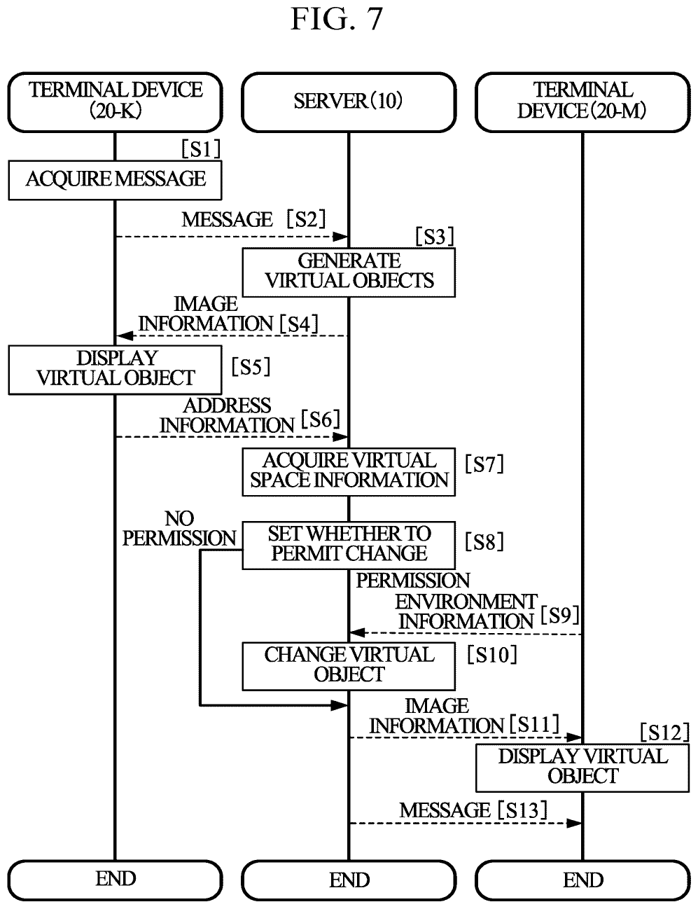

FIG. 7 is a sequence diagram showing an operation of the information processing system 1 according to the First Embodiment. Hereinafter, the operation of the information processing system 1 will be described with reference to FIG. 7.

At step S1, the processor 21 provided in the terminal device 20-K functions as the acquirer 211. The processor 21 acquires a message created by the user U_{K}.

At step S2, the processor 21 provided in the terminal device 20-K functions as the provider 213. The processor 21 transmits the message created by the user U_{K} to the server 10. The processor 11 provided in the server 10 functions as the acquirer 111. The processor 11 acquires the message created by the user U_{K} from the terminal device 20-K.

At step S3, the processor 11 provided in the server 10 functions as the generator 113. The processor 11 generates virtual objects VO1 and VO2 related to the message created by the user U_{K}.

At step S4, the processor 11 provided in the server 10 functions as the provider 116. The processor 11 provides image information indicative of the virtual object VO1 to the terminal device 20-K. The processor 21 provided in the terminal device 20-K functions as the acquirer 211. The processor 21 acquires the image information indicative of the virtual object VO1 from the server 10.

At step S5, the processor 21 provided in the terminal device 20-K functions as the display controller 212. The processor 21 uses the image information acquired at step S4 to cause the display 30-K to display the virtual object VO1.

At step S6, the processor 21 provided in the terminal device 20-K functions as the acquirer 211. The processor 21 acquires address information indicative of an address for the message input by the user U_{K} using, for example, the input device 25. The processor 21 functions as the provider 213. The processor 21 transmits the acquired address information to the server 10. The processor 11 provided in the server 10 functions as the acquirer 111. The processor 11 acquires, from the terminal device 20-K, the address information indicative of the address for the message acquired at step S2. In this case, the address for the message is assumed to be that of the user U_{M}.

At step S7, the processor 11 provided in the server 10 functions as the acquirer 111. The processor 11 uses the address information acquired at step S6 to refer to the registration information database RD. Thus, the processor 11 acquires virtual space information indicating that the second virtual space visually recognized by the user U_{M} is a virtual reality space, that the second virtual space visually recognized by the user U_{M} is an augmented reality space, or that the second virtual space visually recognized by the user U_{M} is a mixed reality space.

At step S8, the processor 11 provided in the server 10 functions as the setter 114. Based on the virtual space information acquired at step S7, the processor 11 sets whether to permit a change in the appearance of the virtual object VO2 to be displayed in the second virtual space. When the second virtual space is a virtual reality space, the processor 11 sets no permission for the change in the appearance of the virtual object VO2. Thereafter, the processor 11 executes an operation in step S11. On the other hand, when the second virtual space is an augmented reality space or a mixed reality space, the processor 11 sets permission for the change in the appearance of the virtual object VO2. Thereafter, the processor 11 executes an operation in step S9.

At step S9, the processor 21 provided in the terminal device 20-M functions as the provider 213. The processor 21 transmits environment information to the server 10. The processor 11 provided in the server 10 functions as the acquirer 111. The processor 11 acquires the environment information from the terminal device 20-M.

At step S9, the processor 11 provided in the server 10 may provide a request signal for a request for environment information to the terminal device 20-M, and the processor 21 provided in the terminal device 20-M may transmit the environment information to the server 10 in response to the request signal. Alternatively, the processor 21 provided in the terminal device 20-M may continuously or intermittently transmit environment information to the server 10, and the processor 11 provided in the server 10 may acquire the environment information.

At step S10, the processor 11 provided in the server 10 functions as the changer 115. The processor 11 changes, based on the environment information acquired at step S9, the appearance of the virtual object VO2 to be displayed in the second virtual space.

At step S11, the processor 11 provided in the server 10 functions as the provider 116. The processor 11 transmits image information indicative of the virtual object VO2 to the terminal device 20-M. The processor 21 provided in the terminal device 20-M functions as the acquirer 211. The processor 21 acquires the image information indicative of the virtual object VO2 from the server 10.

At step S12, the processor 21 provided in the terminal device 20-M functions as the display controller 212. The processor 21 uses the image information acquired at step S4 to cause the display 30-M to display the virtual object VO2.

At step S13, the processor 11 provided in the server 10 functions as the provider 116. The processor 11 transmits the message corresponding to the virtual object VO2 to the terminal device 20-M. For example, when the processor 11 acquires operation information, which indicates an operation for an instruction to display the message related to the virtual object VO2 as an operation of the virtual object VO2 by the user U_{M}, from the terminal device 20-M, the processor 11 transmits the message to the terminal device 20-M. The processor 21 provided in the terminal device 20-M functions as the acquirer 211. The processor 21 acquires the message from the server 10. The processor 21 provided in the terminal device 20-M functions as the display controller 212. The processor 21 causes the display 30-M to display the message.

Thereafter, the processor 21 provided in the terminal device 20-K, the processor 11 provided in the server 10, and the processor 21 provided in the terminal device 20-M terminate all processing shown in FIG. 7.

### 1-3: Effect of First Embodiment

According to the above description, the server 10 that is a display control apparatus includes the generator 113 and the setter 114. The generator 113 generates the virtual object VO1 to be placed in the first virtual space visually recognized by the user U_{K} who is a sender of a message, the virtual object VO1 being related to the message. The setter 114 sets whether to permit a change in the appearance of the virtual object VO2 to be displayed in the second virtual space visually recognized by the user U_{M} who is a recipient of the message.

Since the server 10 includes the configuration described above, the server 10 can set whether to permit the change in the appearance of the virtual object VO2 indicative of the message in a recipient device of the message. More specifically, the appearance of the virtual object VO2 viewed by the user U_{M} varies in accordance with a state of the user U_{M} that receives the message. The server 10 can set whether to permit the change in the appearance of the virtual object VO2; thus, the user U_{M} need not perform a complicated operation so as to make an appearance of the virtual object VO2 be appropriately viewed by the user. In addition, the user U_{K} who is a sender of the message need not manually set, in accordance with a state of the user U_{M} who is a recipient of the message, whether to permit a change in the appearance of the virtual object VO1 displayed as the virtual object VO2 in the second virtual space.

According to the above description, the server 10 further includes the acquirer 111. The acquirer 111 acquires the virtual space information for distinguishing whether the second virtual space is a virtual reality space, an augmented reality space, or a mixed reality space. The setter 114 sets whether to permit the change based on the virtual space information described above.

Since the server 10 includes the configuration described above, the server 10 can set, in accordance with a state in which the space visually recognized by the user U_{M} who is a recipient of the message is a virtual reality space, in which the space visually recognized by the user U_{M} is an augmented reality space, or in which the space visually recognized by the user U_{M} is a mixed reality space, whether to permit the change in the appearance of the virtual object VO2. In addition, the user U_{K} who is a sender of the message need not manually set whether to permit the change in the appearance of the virtual object VO1 displayed as the virtual object VO2 in the second virtual space in a state in which the user U_{K} understands that the space visually recognized by the user U_{M} who is a recipient of the message is a virtual reality space, that the space is an augmented reality space, or that the space is a mixed reality space.

According to the above description, the acquirer 111 acquires the environment information indicative of the environment in the real space in which the recipient of the message is. The server 10 further includes the changer 115. When the second virtual space is an augmented reality space or a mixed reality space and the setter 114 sets permission for the change in the appearance of the virtual object VO2, the changer 115 changes the appearance of the virtual object VO2 in the second virtual space based on the environment information.

Since the server 10 includes the configuration described above, the server 10 can make an appearance of the virtual object VO2 appropriately viewed by the user U_{M}. In particular, when the second virtual space visually recognized by the user U_{M} is an augmented reality space or a mixed reality space, the server 10 can make an appearance of the virtual object VO2 appropriately viewed by the user U_{M} in accordance with an environment in the real space included in the augmented reality space or in the mixed reality space.

### 2: Second Embodiment

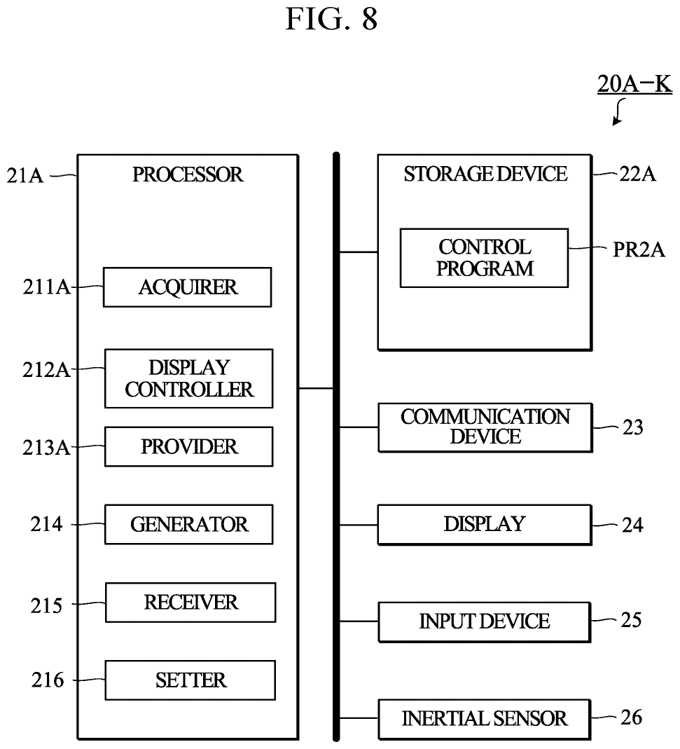

With reference to FIG. 8 to FIG. 10, an information processing system 1A, which includes a terminal device 20A-K as a display control apparatus according to a Second Embodiment of the present invention, will be described. To facilitate explanation, in the following description, among elements provided in the information processing system 1A according to the Second Embodiment, elements having the same configuration as those provided in the information processing system 1 according to the First Embodiment are denoted by the same reference numerals used for like elements in the description of the First Embodiment, and detailed description thereof is omitted as appropriate.

### 2-1: Configuration of Second Embodiment

### 2-1-1: Overall Configuration

The information processing system 1A according to a Second Embodiment differs from the information processing system 1 according to the First Embodiment in that a server 10A is included in place of the server 10, a terminal device 20A-K is included in place of the terminal device 20-K, and a terminal device 20A-M is included in place of the terminal device 20-M. In other elements, since an overall configuration of the information processing system 1A is the same as an overall configuration of the information processing system 1 according to the First Embodiment shown in FIG. 1, drawings and explanation thereof will be omitted.

In the information processing system 1 according to the First Embodiment, the server 10 generates the virtual objects VO1 and VO2 and sets whether to permit a change in the appearance of the virtual object VO2. On the other hand, in the information processing system 1A according to the Second Embodiment, the terminal device 20A-K generates the virtual object VO1. The terminal device 20A-K sets whether to permit a change in the appearance of the virtual object VO1. In addition, the terminal device 20A-M generates the virtual object VO2. More specifically, when the virtual object VO1 is displayed as the virtual object VO2 in the second virtual space, the terminal device 20-K sets whether to permit a change in the appearance of the virtual object VO1 to be displayed as the virtual object VO2 in the second virtual space. In the Second Embodiment, the terminal device 20-K is an example of the display control apparatus.

### 2-1-2: Configuration of Terminal Device

FIG. 8 is a block diagram showing an example of a configuration of the terminal device 20A-K. The terminal device 20A-K differs from the terminal device 20-K in that a processor 21A is included in place of the processor 21 and a storage device 22A is included in place of the storage device 22.

The storage device 22A differs from the storage device 22 and stores a control program PR2A instead of the control program PR2. The storage device 22A further stores the image information indicative of the image to be displayed on the display 30-K. In particular, the storage device 22A stores the image information indicative of the virtual object VO1 to be displayed on the display 30-K. In the terminal device 20A-M rather than in the terminal device 20A-K, the storage device 22A stores the image information indicative of the virtual object VO2 to be displayed on the display 30-M.

The processor 21A includes an acquirer 211A that is in place of the acquirer 211 provided in the processor 21, a display controller 212A that is in place of the display controller 212, and a provider 213A that is in place of the provider 213. The processor 21A further includes a generator 214, a receiver 215, and a setter 216, in addition to elements provided in the processor 21.

The acquirer 211A has the same functions as the acquirer 211 according to the First Embodiment. In the terminal device 20A-M rather than in the terminal device 20A-K, the acquirer 211A acquires change information on a change in the virtual object VO2 from the server 10A.

The generator 214 uses the image information stored in the storage device 22A to generate the virtual object VO1 to be placed in the first virtual space, the virtual object VO1 being related to the message that is created by the user U_{K} and that is acquired by the acquirer 211A. In the terminal device 20A-M rather than in the terminal device 20A-K, the generator 214 uses the image information stored in the storage device 22A and the change information acquired by the acquirer 211A to generate the virtual object VO2 to be placed in the second virtual space, the virtual object VO2 being related to the message from the user U_{K}, the message being acquired by the acquirer 211A.

The display controller 212A causes the display 30-K to display the virtual object generated by the generator 214. In particular, the terminal device 20A-K causes the display 30-K to display the virtual object VO1 generated by the generator 214. On the other hand, the terminal device 20A-M causes the display 30-M to display the virtual object VO2 generated by the generator 214.

The receiver 215 receives an operation by the user U_{K} related to whether to permit a change in the appearance of the virtual object VO1. Specifically, when the user U_{K} does not want to change the appearance of the virtual object VO2 from the appearance of the virtual object VO1 in a state in which the virtual object VO1 is displayed as the virtual object VO2 in the second virtual space, the user U_{K} performs an operation to specify no permission for the change. On the other hand, when the user U_{K} permits a change in the appearance of the virtual object VO2 from the appearance of the virtual object VO1 in a state in which the virtual object VO1 is displayed as the virtual object VO2 in the second virtual space, the user U_{K} performs an operation to specify permission for the change. Those operations may each be an operation by the user U_{K} using the input device 25, or may each be an operation of the virtual object VO1 by the user U_{K}.

The receiver 215 receives an operation of the virtual object VO1 by the user U_{K}. In the terminal device 20A-M rather than in the terminal device 20A-K, the receiver 215 receives an operation of the virtual object VO2 by the user U_{M}.

The setter 216 sets, based on the operation received by the receiver 215, whether to permit a change in the appearance of the virtual object VO2 to be displayed in the second virtual space visually recognized by the user U_{M}. Specifically, the setter 216 generates, based on the operation described above, permission information indicating whether to permit the change in the appearance of the virtual object VO2.

Thus, the terminal device 20A-K can set, in the terminal device 20-K that is a sender of the message, whether to permit the change in the appearance of the virtual object VO2 indicative of the message in a recipient device of the message. The provider 213A has the same functions as the provider 213 according to the First Embodiment. The provider 213 further provides the permission information generated by the setter 216 to the server 10A.

### 2-1-3: Configuration of Server

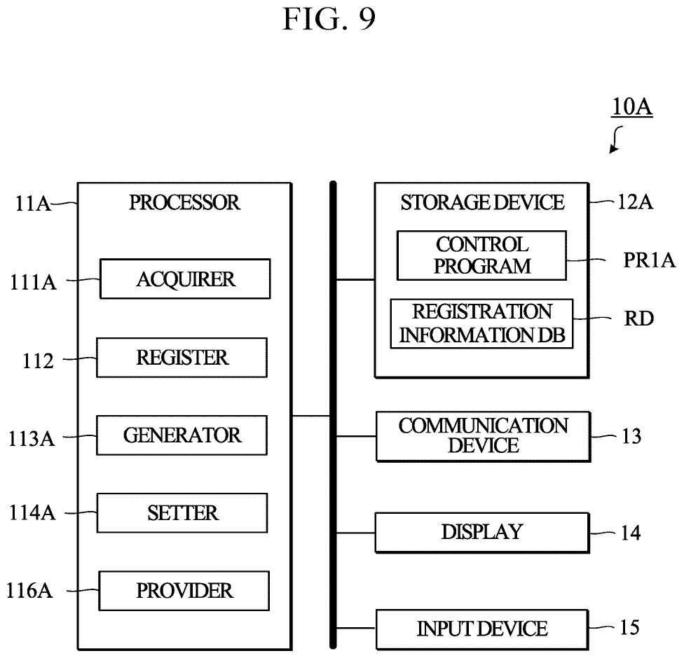

FIG. 9 is a block diagram showing an example of a configuration of the server 10A. The server 10A differs from the server 10 in that a processor 11A is included in place of the processor 11 and a storage device 12A is included in place of the storage device 12.

The storage device 12A differs from the storage device 12 and stores a control program PR1A instead of the control program PR1.

The processor 11A includes an acquirer 111A that is in place of the acquirer 111 provided in the processor 11, a generator 113A that is in place of the generator 113, a setter 114A that is in place of the setter 114, and a provider 116A that is in place of the provider 116. The processor 11A need not include the changer 115 among the elements provided in the processor 11.

The acquirer 111A has the same functions as the acquirer 111 according to the First Embodiment. The acquirer 111A further acquires the permission information described above from the terminal device 20-K.

The setter 114A sets, the permission information and the virtual space information acquired by the acquirer 111, whether to permit a change in the appearance of the virtual object VO2 in the second virtual space visually recognized by the user U_{M}. More specifically, when the permission information described above indicates that the user U_{K} specifies no permission for the change in the appearance of the virtual object VO2, the setter 114A does not permit any change in the appearance of the virtual object VO2. When the permission information described above indicates that the user U_{K} specifies the permission for the change in the appearance of the virtual object VO2 and the second virtual space is a virtual reality space, the setter 114A does not permit any change in the appearance of the virtual object VO2. On the other hand, when the permission information described above indicates that the user U_{K} specifies the permission for the change in the appearance of the virtual object VO2 and the second virtual space is an augmented reality space or a mixed reality space, the setter 114A permits the change in the appearance of the virtual object VO2.

When the setter 114A permits the change in the appearance of the virtual object VO2, the generator 113A generates, based on the environment information acquired by the acquirer 111A, change information related to the change in the appearance of the virtual object VO2 to be displayed in the second virtual space. For example, when the environment information acquired by the acquirer 111A is illuminance information measured by the illuminance sensor, the generator 113A generates change information, which indicates a degree of change in at least one of the brightness, the saturation, and the hue of a color of the virtual object VO2 in accordance with the illuminance information.

The provider 116A provides the change information generated by the generator 113A to the terminal device 20A-M.

### 2-2: Operation of Second Embodiment

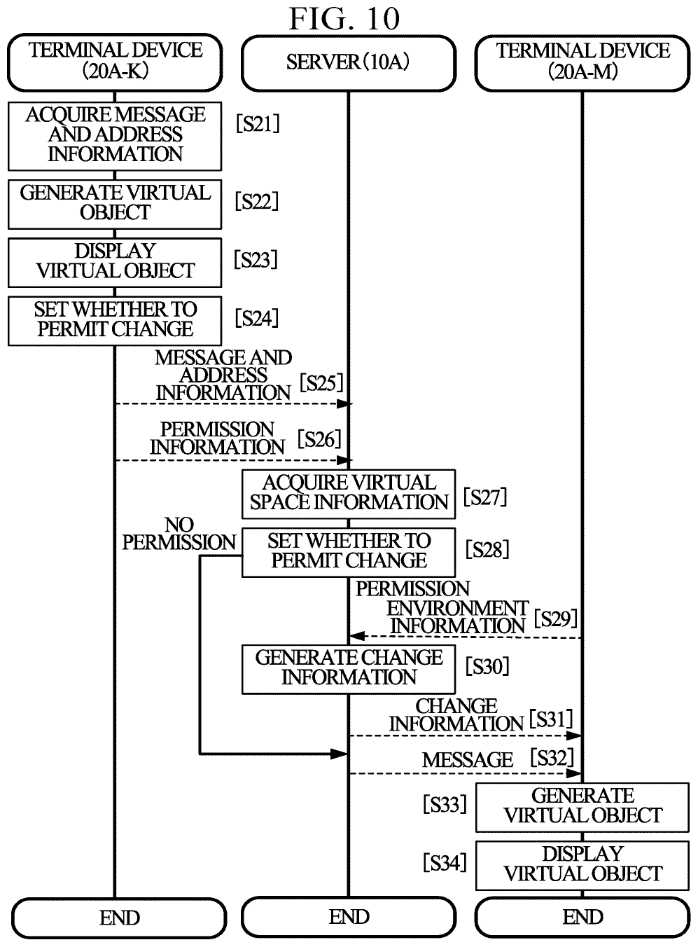

FIG. 10 is a sequence diagram showing an operation of the information processing system 1A according to the Second Embodiment. Hereinafter, the operation of the information processing system 1A will be described with reference to FIG. 10. At step S21, the processor 21A provided in the terminal device 20A-K functions as the acquirer 211A. The processor 21A acquires a message created by the user U_{K} and address information indicative of an address for the message. In this case, the address for the message is assumed to be the user U_{M}.

At step S22, the processor 21A provided in the terminal device 20A-K functions as the generator 214. The processor 21A generates a virtual object VO1 related to the message acquired at step S21.

At step S23, the processor 21A provided in the terminal device 20A-K functions as the display controller 212. The processor 21A causes the display 30-K to display the virtual object VO1 generated at step S22.

At step S24, the processor 21A provided in the terminal device 20A-K functions as the setter 216. The processor 21A sets, based on an operation by the user U_{K}, whether to permit a change in the appearance of the virtual object VO2 to be displayed in the second virtual space visually recognized by the user U_{M}. Specifically, the processor 21A generates permission information indicating whether the change is permitted.

At step S25, the processor 21A provided in the terminal device 20A-K functions as the provider 213A. The processor 21A provides the message and the address information acquired at step S21 to the server 10A. The processor 11A provided in the server 10A functions as the acquirer 111A. The processor 11A acquires the message and the address information from the terminal device 20A-K.

At step S26, the processor 21A provided in the terminal device 20A-K functions as the provider 213A. The processor 21A provides the permission information generated at step S24 to the server 10A. The processor 11A provided in the server 10A functions as the acquirer 111A. The processor 11A acquires the permission information from the terminal device 20A-K.

At step S27, the processor 11A provided in the server 10A functions as the acquirer 111A. The processor 11A uses the address information acquired at step S26 to refer to the registration information database RD. Thus, the processor 11A acquires virtual space information for distinguishing whether the second virtual space visually recognized by the user U_{M} is a virtual reality space, an augmented reality space, or a mixed reality space.

At step S28, the processor 11A provided in the server 10A functions as the setter 114A. The processor 11A sets, based on the permission information acquired at step S26 and on the virtual space information acquired at step S27, whether to permit a change in the appearance of the virtual object VO2 to be displayed in the second virtual space. More specifically, when the permission information described above indicates that the user U_{K} specifies no permission for the change in the appearance of the virtual object VO2, the processor 11A does not permit any change in the appearance of the virtual object VO2. When the permission information described above indicates that the user U_{K} specifies the permission for the change in the appearance of the virtual object VO2 and the second virtual space is a virtual reality space, the processor 11A does not permit any change in the appearance of the virtual object VO2. Thereafter, the processor 11A executes an operation in step S32. On the other hand, when the permission information described above indicates that the user U_{K} specifies the permission for the change in the appearance of the virtual object VO2 and the second virtual space is an augmented reality space or a mixed reality space, the processor 11A permits the change in the appearance of the virtual object VO2. Thereafter, the processor 11 executes an operation in step S29.

At step S29, the processor 21A provided in the terminal device 20A-M functions as the provider 213A. The processor 21A provides environment information to the server 10A. The processor 11A provided in the server 10A functions as the acquirer 111A. The processor 11A acquires the environment information from the terminal device 20A-M.

At step S29, the processor 11A provided in the server 10A may provide a request signal for a request for environment information to the terminal device 20A-M, and the processor 21A provided in the terminal device 20A-M may transmit the environment information to the server 10A in response to the request signal. Alternatively, the processor 21A provided in the terminal device 20A-M may continuously or intermittently provide environment information to the server 10A, and the processor 11A provided in the server 10A may acquire the environment information.

At step S30, the processor 11A provided in the server 10A functions as the generator 113A. The processor 11A generates, based on the environment information acquired at step S29, change information related to the change in the appearance of the virtual object VO2 to be displayed in the second virtual space.

At step S31, the processor 11A provided in the server 10A functions as the provider 116A. The processor 11A provides the change information generated at step S30 to the terminal device 20-M. The processor 21A provided in the terminal device 20A-M functions as the acquirer 211A. The processor 21A acquires the change information from the server 10A.

At step S32, the processor 11A provided in the server 10A functions as the provider 116A. The processor 11A provides the message acquired at step S25 to the terminal device 20-M. The processor 21A provided in the terminal device 20A-M functions as the acquirer 211A. The processor 21A acquires the message from the server 10A.

At step S33, the processor 21A provided in the terminal device 20A-M functions as the generator 214. The processor 21A uses the image information stored in the storage device 22A and the change information acquired at step S31 to generate a virtual object VO2 related to the message acquired at step S32.

At step S34, the processor 21A provided in the terminal device 20A-M functions as the display controller 212A. The processor 21A causes the display 30-M to display the virtual object VO2 generated at step S33. Thereafter, the processor 21A displays the message acquired at step S32. For example, the processor 21A provided in the terminal device 20A-M functions as the receiver 215. The processor 21A receives an operation for an instruction to display the message related to the virtual object VO2 as an operation of the virtual object VO2 by the user U_{M}. The processor 21A functions as the display controller 212A. The processor 21A causes the display 30-M to display the message.

Thereafter, the processor 21A provided in the terminal device 20A-K, the processor 11A provided in the server 10A, and the processor 21A provided in the terminal device 20A-M, terminate all processing shown in FIG. 10.

### 2-3: Effect of Second Embodiment

According to the above description, the terminal device 20A-K that is a display control apparatus includes the generator 214 and the setter 216. The generator 214 generates the virtual object VO1 to be placed in the virtual reality space VS that is the first virtual space visually recognized by the user U_{K} who is a sender of a message, the virtual object VO1 being related to the message. The setter 216 sets whether to permit a change in the appearance of the virtual object VO2 to be displayed in the augmented reality space AS that is the second virtual space visually recognized by the user U_{M} who is a recipient of the message.

Since the terminal device 20A-K includes the above configuration, the terminal device 20A-K that is a sender device of the message can set whether to permit the change in the appearance of the virtual object VO2 indicative of the message in a recipient device of the message. More specifically, the appearance of the virtual object VO2 viewed by the user U_{M} varies in accordance with a state of the user U_{M} that receives the message. The sender of the message can set whether to permit the change in the appearance of the virtual object VO2; thus, the user U_{M} need not perform a complicated operation so as to make an appearance of the virtual object VO2 appropriately viewed by the user.

### 3: Modifications

This disclosure is not limited to the embodiment described above. Specific modifications will be explained below. Two or more modifications freely selected from the following modifications may be combined.

### 3-1: First Modification

In the server 10 according to the First Embodiment, the setter 114 sets whether to permit the change in the appearance of the virtual object VO2. In the terminal device 20A-K according to the Second Embodiment, the setter 216 sets whether to permit the change in the appearance of the virtual object VO2. The setter 114 and the setter 216 may further set whether to permit a change in all the appearance of the virtual object VO2, or may further set whether to permit a change in a part of the appearance of the virtual object VO2.

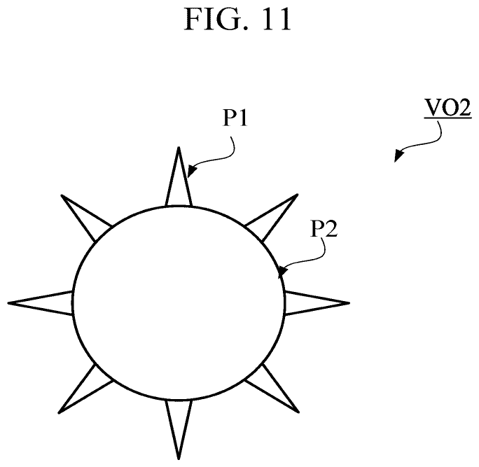

FIG. 11 shows an example of the virtual object VO2. The virtual object VO2 shown in FIG. 11 differs in shape from the virtual object VO2 shown in FIG. 3. The virtual object VO2 shown in FIG. 11 includes protrusions P1 and a spherical portion P2. For example, the setter 114 and the setter 216 may set whether to permit a change in all the appearance of the virtual object VO2, or may set whether to permit a change in either the protrusions P1 or the spherical portion P2.

Thus, the server 10 or the terminal device 20A-K can change only a part of the appearance of the virtual object VO2 in accordance with needs of the user U_{M}.

### 3-2: Second Modification

The server 10 according to the First Embodiment includes the register 112 and stores the registration information database RD. However, the server 10 need not include the register 112 and need not store the registration information database RD. In this case, the acquirer 111 may acquire the virtual space information directly from the terminal device 20-M instead of acquiring the virtual space information by referring to the registration information database RD. The same manner may be applied to the server 10A according to the Second Embodiment.

### 3-3: Third Modification

In the First Embodiment, the virtual space information described above is “information for distinguishing whether the second virtual space visually recognized by the user U_{M} corresponding to the address information is a virtual reality space, an augmented reality space, or a mixed reality space.” However, the virtual space information is not limited to the information. For example, as described above, the registration information database RD stores the information indicative of the type of display 30-K, which is worn on the head of the user U_{K}, in association with the user U_{K}, and the information indicative of the type of display 30-M, which is worn on the head of the user U_{M}, in association with the user U_{M}. Thus, the virtual space information may be device information of the display 30-M worn by the user U_{M}. In this case, the setter 114 provided in the server 10 sets, based on the device information of the display 30-M, whether to permit a change in the appearance of the virtual object VO2 in the second virtual space visually recognized by the user U_{M}. More specifically, in accordance with the type of display 30-M worn by the user U_{M}, a virtual space provided to the user U_{M} is changed between a virtual reality space, an augmented reality space, and a mixed reality space. Thus, the setter 114 provided in the server 10 can set, based on the device information of the display 30-M that is the virtual space information, whether to permit the change. The registration information database RD may store the information indicative of the type of terminal device 20-K, which is used by the user U_{K}, in association with the user U_{K}, and the information indicative of the type of terminal device 20-M, which is used by the user U_{M}, in association with the user U_{M}. In this case, similarly, the virtual space information may be device information of the terminal device 20-M used by the user U_{M}. The same manner may be applied to the server 10A according to the Second Embodiment.

### 3-4: Fourth Modification

In the information processing system 1A according to the Second Embodiment, the acquirer 111A provided in the server 10A refers to the registration information database RD to acquire the virtual space information, and the setter 114A uses the virtual space information to set whether to permit a change in the appearance of the virtual object VO2 in the second virtual space visually recognized by the user U_{M}. However, the acquirer 211A provided in the terminal device 20A-K may read the registration information database RD from the server 10A to acquire the virtual space information, and the setter 216 may use the virtual space information to set whether to permit a change in the appearance of the virtual object VO2 in the second virtual space visually recognized by the user U_{M}. In this case, the server 10A need not include the setter 114A.

### 3-5: Fifth Modification

In the information processing system 1A according to the Second Embodiment, the generator 113A provided in the server 10A generates, based on the environment information acquired from the terminal device 20A-M, the change information related to a change in the appearance of the virtual object VO2 to be displayed in the second virtual space. However, the terminal device 20A-M rather than the server 10A may generate the change information. More specifically, when the server 10A provides permission information to the terminal device 20A-M and the permission information acquired by the terminal device 20A-M indicates permission for a change in the appearance of the virtual object VO2, the terminal device 20A-M may generate the change information based on the environment information. Thereafter, the generator 214 provided in the terminal device 20A-M uses the image information stored in the storage device 22A and the change information described above to generate the virtual object VO2. Similarly, in the information processing system 1 according to the First Embodiment, the terminal device 20-M may generate the change information based on the environment information. In this case, the terminal device 20-M uses the image information acquired from the server 10 to cause the display 30-M to display the virtual object VO2, and then it changes the appearance of the virtual object VO2 by applying the change information to the image information.

### 3-6: Sixth Modification

In the information processing system 1A according to the Second Embodiment, the receiver 215 provided in the terminal device 20A-K receives the operation by the user U_{K}, the operation being related to whether to permit a change in the appearance of the virtual object VO1. The setter 216 provided in the terminal device 20A-K sets, based on the operation received by the receiver 215, whether to permit a change in the appearance of the virtual object VO2 to be displayed in the second virtual space visually recognized by the user U_{M}. However, the terminal device 20A-K need not include the receiver 215 and the setter 216. In this case, although the terminal device 20A-K generates the virtual object VO1, the server 10A sets whether to permit a change in the appearance of the virtual object VO2 in the same manner as the information processing system 1 according to the First Embodiment.

### 3-7: Seventh Modification

In the information processing system 1A according to the Second Embodiment, the terminal device 20A-K includes the receiver 215 and the setter 216, whereas in the information processing system 1 according to the First Embodiment, the terminal device 20-K does not include the same elements as those. However, the terminal device 20-K may include elements having configurations that are the same as those of the receiver 215 and the setter 216. Thus, in the information processing system 1 according to the First Embodiment, the terminal device 20-K can set whether to permit a change in the appearance of the virtual object VO2.

### 3-8: Eighth Modification

In the information processing system 1 according to the First Embodiment, the server 10 independently sets whether to permit a change in the appearance of the virtual object VO2. In the information processing system 1A according to the Second Embodiment, the terminal device 20A-K includes the receiver 215 and the setter 216 to set, based on the operation by the user U_{K}, whether to permit a change in the appearance of the virtual object VO2. Prior to executing these processing, the server 10 or the terminal device 20A-K may inquire of the user U_{K} whether to permit the change. In this case, the user U_{K} uses the terminal device 20-K to perform an operation for setting whether to permit the change, and the server 10 or the terminal device 20-K sets, based on the operation, whether to permit the change.

### 3-9: Ninth Modification

In the information processing system 1 according to the First Embodiment, the terminal device 20-K and the display 30-K are implemented to be separate from each other. However, a way to implement the terminal device 20-K and the display 30-K according to this embodiment of the present invention is not limited thereto. For example, the display 30-K may include functions that are the same as those of the terminal device 20-K. In other words, the terminal device 20-K and the display 30-K may be implemented in a single housing. The same manner may be applied to the terminal device 20-M and the display 30-M. The same manner may be applied to the information processing system 1A according to the Second Embodiment.

### 4: Other Matters

(1) In the foregoing embodiments, the storage devices 12 and 12A, the storage devices 22 and 22A, and the storage device 32 are each, for example, a ROM and a RAM; however, the storage devices may include flexible disks, magneto-optical disks (e.g., compact disks, digital multi-purpose disks, Blu-ray (registered trademark) discs, smart-cards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. The program may be transmitted by a network via telecommunication lines. Alternatively, the program may be transmitted by a communication network NET via telecommunication lines.
(2) In the foregoing embodiments, information, signals, etc., may be presented by use of various techniques. For example, data, instructions, commands, information, signals, bits, symbols, chips, etc., may be presented by freely selected combination of voltages, currents, electromagnetic waves, magnetic fields or magnetic particles, light fields or photons.
(3) In the foregoing embodiments, the input and output of information, or the input or the output of information, etc., may be stored in a specific location (e.g., memory) or may be managed by use of a management table. The information, etc., that is, the input and output, or the input or the output, may be overwritten, updated, or appended. The information, etc., that is output may be deleted. The information, etc., that is input may be transmitted to other devices.
(4) In the foregoing embodiments, determination may be made based on values that can be represented by one bit (0 or 1), may be made based on Boolean values (true or false), or may be made based on comparing numerical values (for example, comparison with a predetermined value).
(5) The order of processes, sequences, flowcharts, etc., that have been used to describe the foregoing embodiments may be changed as long as they do not conflict. For example, although a variety of methods has been illustrated in this disclosure with a variety of elements of steps in exemplary orders, the specific orders presented herein are by no means limiting.
(6) Each function shown in FIG. 1 to FIG. 11 is implemented by any combination of hardware and software. The method for realizing each functional block is not limited thereto. That is, each functional block may be implemented by one device that is physically or logically aggregated. Alternatively, each functional block may be realized by directly or indirectly connecting two or more physically and logically separate, or physically or logically separate, devices (by using cables and radio, or cables, or radio, for example), and using these devices. The functional block may be realized by combining the software with one device described above or two or more of these devices.
(7) The programs shown in the foregoing embodiments should be widely interpreted as an instruction, an instruction set, a code, a code segment, a program code, a subprogram, a software module, an application, a software application, a software package, a routine, a subroutine, an object, an executable file, an execution thread, a procedure, a function, or the like, regardless of whether it is called software, firmware, middleware, microcode, hardware description language, or by other names.
Software, instructions, etc., may be transmitted and received via communication media. For example, when software is transmitted by a website, a server, or other remote sources, by using wired technologies such as coaxial cables, optical fiber cables, twisted-pair cables, and digital subscriber lines (DSL), and wireless technologies such as infrared radiation and radio and microwaves by using wired technologies, or by wireless technologies, these wired technologies and wireless technologies, wired technologies, or wireless technologies, are also included in the definition of communication media.
(8) In each aspect, the terms “system” and “network” are used interchangeably.
(9) The information and parameters described in this disclosure may be represented by absolute values, may be represented by relative values with respect to predetermined values, or may be represented by using other pieces of applicable information.
(10) In the foregoing embodiments, the terminal devices 20-1 to 20-J, 20A-K, and 20A-M and the servers 10 and 10A may each be a mobile station (MS). A mobile station may be referred to, by one skilled in the art, as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other suitable terms. The terms “mobile station”, “user terminal”, “user equipment (UE)”, “terminal”, etc., may be used interchangeably in the present disclosure.
(11) In the foregoing embodiments, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be replaced with “access.” As used in this specification, two elements may be considered “connected” or “coupled” to each other by using one or more electrical wires, cables, and printed electrical connections, or by using one or more electrical wires, cables, or printed electrical connections. In addition, two elements may be considered “connected” or “coupled” to each other by using electromagnetic energy, etc., which is a non-limiting and non-inclusive example, having wavelengths in radio frequency regions, microwave regions, and optical (both visible and invisible) regions.
(12) In the foregoing embodiments, the phrase “based on” as used in this specification does not mean “based only on”, unless specified otherwise. In other words, the phrase “based on” means both “based only on” and “based at least on.”
(13) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining, etc., has taken place. Furthermore, “determining” may be used when practically “determining” that some act of receiving (for example, receiving information), transmitting (for example, transmitting information), inputting, outputting, accessing (for example, accessing data in a memory) etc., has taken place. Furthermore, “determining” may be used when practically “determining” that some act of resolving, selecting, choosing, establishing, comparing, etc., has taken place. That is, “determining” may be used when practically determining to take some action. The term “determining” may be replaced with “assuming”, “expecting”, “considering”, etc.
(14) As long as terms such as “include”, “including” and modifications thereof are used in the foregoing embodiments, these terms are intended to be inclusive, in a manner similar to the way the term “comprising” is used. In addition, the term “or” used in the specification or in claims is not intended to be an exclusive OR.
(15) In the present disclosure, for example, when articles such as “a”, “an”, and “the” in English are added in translation, these articles include plurals unless otherwise clearly indicated by the context.
(16) In this disclosure, the phrase “A and B are different” may mean “A and B are different from each other.” The phrase “A and B are different from C, respectively” may mean that “A and B are different from C”. Terms such as “separated” and “combined” may be interpreted in the same way as “different.”
(17) The examples and embodiments illustrated in this specification may be used individually or in combination, which may be altered depending on the mode of implementation. A predetermined piece of information (for example, a report to the effect that something is “X”) does not necessarily have to be indicated explicitly, and may be indicated in an implicit way (for example, by not reporting this predetermined piece of information, by reporting another piece of information, etc.).

Although this disclosure is described in detail, it is obvious to those skilled in the art that the present invention is not limited to these embodiments described in the specification. This disclosure can be implemented with a variety of changes and in a variety of modifications, without departing from the spirit and scope of the present invention as defined in the recitations of the claims. Consequently, the description in this specification is provided only for the purpose of explaining examples and should by no means be construed to limit the present invention in any way.

### DESCRIPTION OF REFERENCE SIGNS

1, 1A . . . information processing system, 10, 10A . . . server, 11, 11A . . . processor, 12, 12A . . . storage device, 13 . . . communication device, 14 . . . display, 15 . . . input device, 20, 20A . . . terminal device, 21, 21A . . . processor, 22, 22A . . . storage device, 23 . . . communication device, 24 . . . display, 25 . . . input device, 26 . . . inertial sensor, 30 . . . display, 31 . . . processor, 32 . . . storage device, 33 . . . line-of-sight detector, 34 . . . . GPS device, 35 . . . movement detector, 36 . . . capturing device, 37 . . . environment sensor, 38 . . . communication device, 39 . . . display, 41L, 41R . . . lens, 91, 92 . . . temple, 93 . . . bridge, 94, 95 . . . frame, 111, 111A . . . acquirer, 112 . . . register, 113, 113A . . . generator, 114, 114A . . . setter, 115 . . . changer, 116, 116A . . . provider, 211, 211A . . . acquirer, 212, 212A . . . display controller, 213, 213A . . . provider, 214 . . . generator, 215 . . . receiver, 216 . . . setter, 311 . . . acquirer, 312 . . . display controller, P1 . . . protrusion, P2 . . . spherical portion, PR1 to PR3A . . . control program, VO1, VO2 . . . virtual object.

1. A display control apparatus comprising:
a generator configured to generate a virtual object to be placed in a first virtual space visually recognized by a user who is a sender of a message, the virtual object being related to the message; and
a setter configured to set whether to permit a change in an appearance of the virtual object to be displayed in a second virtual space visually recognized by a user who is a recipient of the message.

2. The display control apparatus according to claim 1,
further comprising an acquirer configured to acquire virtual space information for distinguishing whether the second virtual space is a virtual reality space, an augmented reality space, or a mixed reality space, and
wherein the setter is configured to set, based on the virtual space information,
whether to permit the change in the appearance of the virtual object.

3. The display control apparatus according to claim 2,
further comprising a changer,
wherein the acquirer is configured to acquire environment information indicative of an environment in a real space in which the recipient of the message exists, and
wherein when the second virtual space is an augmented reality space or a mixed reality space and the setter permits the change in the appearance, the changer is configured to change the appearance of the virtual object in the second virtual space based on the environmental information.

4. The display control apparatus according to claim 1,
wherein when the change in the appearance is permitted, the setter is configured to further:
set whether to permit a change in all the appearance of the virtual object; or
set whether to permit a change in a part of the appearance of the virtual object.

5. The display control apparatus according to claim 2,
wherein when the change in the appearance is permitted, the setter is configured to further:
set whether to permit a change in all the appearance of the virtual object; or
set whether to permit a change in a part of the appearance of the virtual object.

6. The display control apparatus according to claim 3,
wherein when the change in the appearance is permitted, the setter is configured to further:
set whether to permit a change in all the appearance of the virtual object; or
set whether to permit a change in a part of the appearance of the virtual object.
